(19) United States
(12) Patent Application Publication
(10) Pub. No.: US 2025/0275007 A1
(43) Pub. Date: Aug. 28, 2025

(54) UPDATE OF TRANSMISSION CONFIGURATION INDICATOR AND BANDWIDTH PART SWITCHING FOR MULTIPLE COMPONENT CARRIERS

(71) Applicant: Apple Inc., Cupertino, CA (US)

(72) Inventors: Yushu Zhang, Beijing (CN); Fangli Xu, Beijing (CN); Qiming Li, Beijing (CN); Yuqin Chen, Beijing (CN); Haitong Sun, Cupertino, CA (US); Wei Zeng, Saratoga, CA (US); Yang Tang, San Jose, CA (US); Haijing Hu, Los Gatos, CA (US); Dawei Zhang, Saratoga, CA (US)

(21) Appl. No.: 18/858,108

(22) PCT Filed: Apr. 21, 2022
(86) PCT No.: PCT/CN2022/088150

§ 371 Date: Oct. 18, 2024

(51) Int. Cl. H04W 76/20; H04L 5/00; H04W 72/0453; H04W 72/231

(52) U.S. Cl. CPC H04W 76/20; H04L 5/001; H04W 72/0453; H04W 72/231

(57) ABSTRACT

A user equipment (UE) includes a transceiver and a processor. The processor is configured to receive, via the transceiver, a common transmission configuration indicator (TCI) identifier (ID) indication for a set of target component carriers (CCs) within a set of multiple CCs; identify, within the set of multiple CCs, the set of target CCs to which the common TCI ID indication applies; and activate, for each CC in the set of target CCs and in accord with the common TCI ID indication, a respective TCI state in at least one TCI state list.

### TECHNICAL FIELD

This application relates generally to wireless communication systems, including methods and implementations of updating a transmission configuration indicator (TCI), or switching a bandwidth part (BWP), for multiple component carriers (CCs).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANS can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIGS. 2A and 2B illustrate example TCI indications for a CC configured in a joint TCI configuration mode.

FIGS. 3A and 3B illustrate example TCI indications for a CC configured in a separate TCI configuration mode.

FIG. 4 shows example TCI state lists for each of first and second CCs, and a common TCI identifier (ID) for the first and second CCs.

FIG. 5 shows an example timeline for a common TCI ID switch.

FIG. 6 shows an example method of wireless communication by a UE, which method may be used to apply a common TCI ID indication to multiple CCs.

FIG. 7 shows an example application of a common TCI ID indication to a set of multiple CCs.

FIG. 8 shows an example application of a common TCI ID indication to a set of BWPs of a set of multiple CCs.

FIG. 9 shows an example method of wireless communication by a UE, which method may be used to switch BWPs for multiple CCs.

FIG. 10 shows an example BWP switching for multiple CCs.

FIG. 11 shows an example method of wireless communication by a base station, which method may be used to apply a common TCI ID indication to multiple CCs.

FIG. 12 shows an example method of wireless communication by a base station, which method may be used to switch BWPs for multiple CCs.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

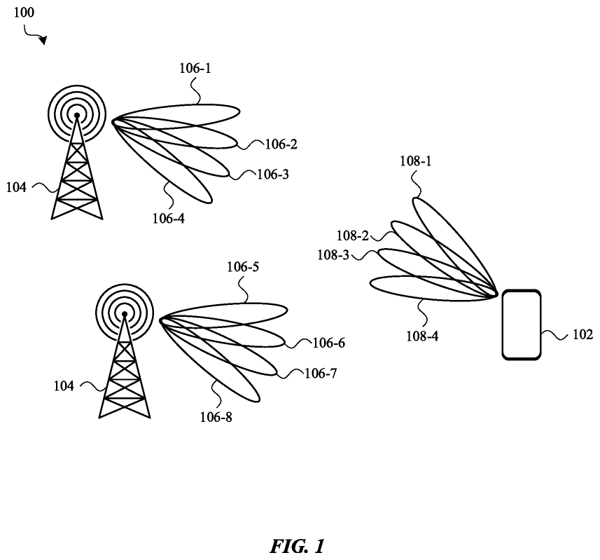

FIG. 1 shows an example wireless communication system 100, according to embodiments described herein. The wireless communication system 100 may operate in accord with the LTE system standards, 5G or NR system standards, or other standards provided by 3GPP technical specifications.

As shown in FIG. 1, the wireless communication system 100 may include a UE 102 and one or more base stations 104 (e.g., eNBs or gNBs). The UE 102 may communicate with one or both of the base stations 104, sequentially (e.g., in a handover scenario) or simultaneously (e.g., in a multiple transmission and reception point (multi-TRP) scenario). The UE 102 may also communicate with other base stations 104. In some embodiments, the UE 102 may be one of multiple UEs that simultaneously or contemporaneously communicate with one or both of the base stations 104 (or other base stations). In some embodiments, one or both of the base stations 104, alone or in combination with one or more other base stations, may form part or all of a cellular RAN.

In some cases, one or both of the base stations 104 may transmit one or more DL channels to the UE 102. The DL channels may be transmitted on one or multiple DL beams 106 (e.g., DL beams 106-1, 106-2, 106-3, and/or 106-4, or DL beams 106-5, 106-6, 106-7, and/or 106-8). Similarly, the UE 102 may transmit one or more UL channels to the base station 104. The UL channels may be transmitted on one or multiple UL beams 108 (e.g., UL beam 108-1, 108-2, 108-3, and/or 108-4).

In some cases, the UE 102 and a base station 104 may communicate on a single CC. In other cases, the UE 102 and the base station 104 may communicate on multiple CCs in a carrier aggregation (CA) mode. The UE 102 may also communicate with more than one base station 104 simultaneously over a set of multiple CCs.

In 3GPP Release 17 (Rel-17), a TCI framework for unified beam management (BM) is described. In accord with the TCI framework, radio resource control (RRC) may be used to identify a set of TCI states (e.g., a TCI state list or pool) for at least one of a number of CCs that have been configured to a UE in a CA mode. A TCI state pool may be identified for one or more CCs and, in some cases, shared with one or more other CCs. A base station may indicate to the UE, in a medium access control (MAC) control element (CE) or downlink control information (DCI, such as DCI format 1_1/1_2), which TCI state in a TCI state list or pool is to be used for transmission of various DL and/or UL channels over a CC. The TCI state may be indicated to the UE by means of a TCI ID.

The TCI states in a TCI state list may include TCI states associated with one or more different TCI configuration modes. For example, a TCI state may be provided for a joint TCI configuration mode (i.e., a mode in which a joint TCI state indicates a downlink reference signal for beam indication for both DL and UL channels) or a separate TCI configuration mode (i.e., a mode in which a separate TCI state (e.g., a DL TCI state or an UL TCI state) indicates a downlink reference signal for beam indication for DL channels or UL channels, but not both).

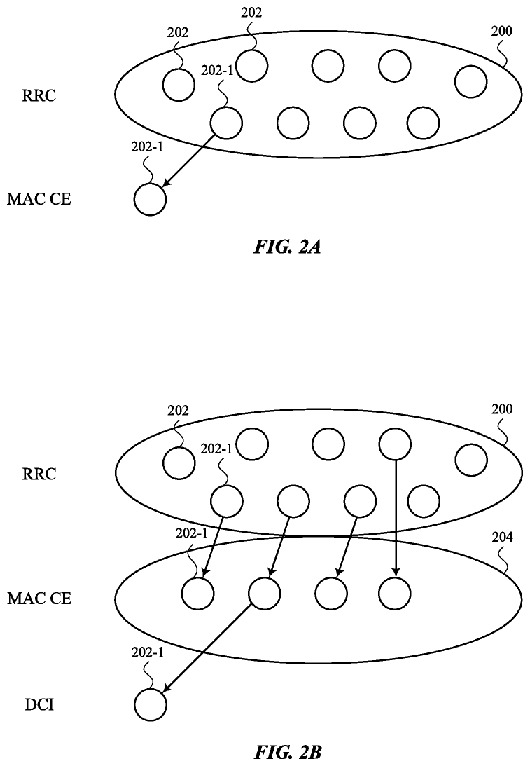

FIGS. 2A and 2B illustrate example TCI indications for a CC configured in a joint TCI configuration mode. As shown in each of FIGS. 2A and 2B, a base station may use RRC signaling to identify, for a UE, a TCI state list (or pool) 200 including a number of possible joint TCI states 202 for a CC. As shown in FIG. 2A, the base station may indicate, to the UE and in a MAC CE, which of the joint TCI states 202 (e.g., joint TCI state 202-1) is to be used by a CC for receiving DL channels and/or transmitting UL channels over the CC. Alternatively, and as shown in FIG. 2B, the base station may indicate, to the UE and in DCI, which of the joint TCI states 202 (e.g., joint TCI state 202-1) is to be used by a CC for receiving DL channels and/or transmitting UL channels over the CC. Optionally, the base station may indicate a down-selection of “active” joint TCI states 204 in a MAC CE, and then indicate a selection of a joint TCI state from among the down-selection of active joint TCI states 204. In either of the embodiments shown in FIGS. 2A and 2B, the joint TCI state 202-1 may be indicated to the UE by means of a TCI ID.

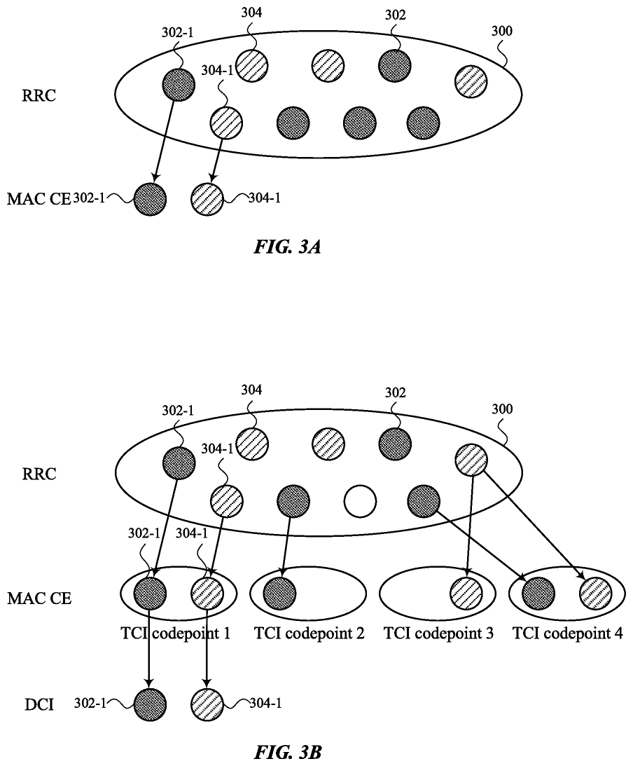

FIGS. 3A and 3B illustrate example TCI indications for a CC configured in a separate TCI configuration mode. As shown in each of FIGS. 3A and 3B, a base station may use RRC signaling to identify, for a UE, a TCI state list (or pool) 300 including a number of possible separate TCI states (e.g., DL TCI states 302 and UL TCI states 304) for a CC. As shown in FIG. 3A, the base station may indicate, to the UE and in a MAC CE, which of the separate TCI states 302 (e.g., DL TCI state 302-1 and UL TCI state 304-1) are to be used by a CC for receiving DL channels and/or transmitting UL channels over the CC. Alternatively, and as shown in FIG. 3B, the base station may indicate, to the UE and in DCI, which of the separate TCI states 302 (e.g., DL TCI state 302-1 and UL TCI state 304-1) are to be used by a CC for receiving DL channels and/or transmitting UL channels over the CC. Optionally, the base station may indicate a down-selection of “active” separate TCI states 306 (TCI codepoints) in a MAC CE, and then indicate a selection of a one or more separate TCI states in terms of a selected TCI codepoint. Although FIGS. 3A and 3B both show selections of a DL TCI state 302-1 and an UL TCI state 304-1, a base station may alternatively select only a DL TCI state or an UL TCI state, as illustrated by TCI codepoints 2 and 3. In either of the embodiments shown in FIGS. 3A and 3B, the separate TCI states 302-1 and 304-1 may be indicated to the UE by means of a TCI ID, which in these examples may include a TCI codepoint.

An indicated TCI ID can be applied to (i.e., may be common to) multiple channels within a serving cell, or across multiple serving cells (or CCs) in a CA scenario. A target set of serving cells, to which a TCI ID is to be applied, may be identified in a serving cell list configured by RRC signaling.

TCI state list sharing across serving cells is supported. A base station may optionally configure a TCI state list by RRC for one BWP in a serving cell. When a TCI state list is not configured, the TCI state list for a reference BWP in a serving cell may be used.

To simplify beam management, a base station may provide, to a UE and in a MAC CE or DCI, a common TCI ID indication. A common TCI ID may identify a set of commonly indexed TCI states, in the TCI state lists of multiple CCs, that is to be applied to the set of multiple CCs. The common TCI ID may be associated with the same or different TCI states in the TCI state lists for different CCs.

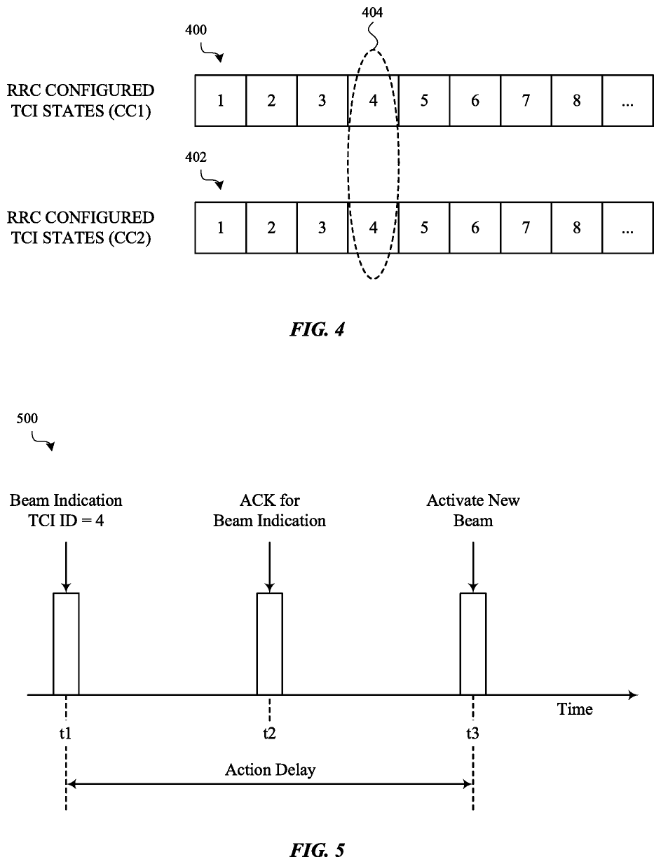

FIG. 4 shows example TCI state lists 400, 402 for each of first and second CCs, and a common TCI ID 404 for the first and second CCs. The first and second CCs are respectively identified as CC1 and CC2. The RRC configured TCI state list 400, 402 for each CC includes TCI states that are consecutively number 1, 2, 3, 4, and so on for each CC. By way of example, common TCI ID 4 is associated with TCI state 4 for each of CCI and CC2. TCI state 4 may be the same for both CC1 and CC2, or TCI state 4 may be different for each of CCI and CC2.

From time-to-time, a base station may switch the common TCI ID that is to be applied to a set of configured CCs for a UE. FIG. 5 shows an example timeline 500 for such a switch. At time t1, the UE may be communicating with the base station, in a CA mode, in accord with a first common TCI ID (e.g., common TCI ID 2). Also at time t1, the UE may receive, from the base station, a command to switch to a second common TCI ID (e.g., common TCI ID 4). In response to receiving the command, the UE may transmit, to the base station, an acknowledgement (ACK) of the command. The ACK may be transmitted at time t2, subsequent to time t1. Following transmission of the ACK, the UE may decode the second common TCI ID, optionally perform a receive (Rx) beam sweep, and perform other operations before the second common TCI ID is activated at time t3, subsequent to time t2. The time period between t1 and t3 is referred to as an action delay (i.e., a delay that is incurred before the UE can activate (or apply) the second common TCI ID to its uplink (UL) and/or downlink (DL) communications with the base station).

The unified TCI framework can in some cases be used for uplink panel selection (i.e., antenna panel selection) and inter-cell mobility. For uplink panel selection, a UE can report the panel entity index (e.g., a capability index on maximum number of sounding reference signal (SRS) ports) for each beam of the base station.

A base station can provide a TCI indication as well as a higher layer parameter update (e.g., UL codebook, max rank for UL transmission, or SRS transmission based on number of antenna ports on panel, etc.) based on the beam report when panel switching happens.

Usually the panel to be used for multiple CCs that share the same antenna should be the same (so if there is need to switch a panel for one CC, a base station should switch the panel for other CCs sharing the same antenna).

For inter-cell mobility, a base station can indicate a TCI associated with a neighbor cell reference signal.

A base station may need to update higher layer parameters to communicate with a UE from a neighbor cell.

Usually the target physical cell for multiple CCs within a band or band combination should be the same.

A base station can configure different higher layer parameters for different BWPs.

With the above context, one issue that may arise is how to support a common TCI ID indication, for a set of multiple CCs, when the CCs have different TCI configuration modes (e.g., separate TCI or joint TCI configuration modes). Another issue is how to identify target applicable BWPs for CCs in the set of multiple CCs. Another issue may be reducing the overhead for TCI state activation.

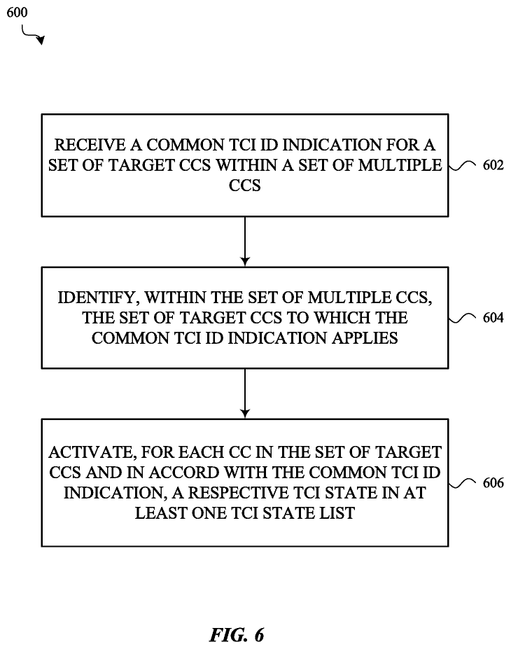

FIG. 6 shows an example method 600 of wireless communication by a UE, which method 600 may be used to apply a common TCI ID indication to multiple CCs. The method 600 may be performed by a processor of the UE, and transmissions and receptions initiated by the processor may be made using a transceiver of the UE.

At 602, the method 600 may include receiving (e.g., from a base station) a common TCI ID indication for a set of target CCs within a set of multiple CCs.

At 604, the method 600 may include identifying, within the set of multiple CCs, the set of target CCs to which the common TCI ID indication applies.

At 606, the method 600 may include activating, for each CC in the set of target CCs and in accord with the common TCI ID indication, a respective TCI state in at least one TCI state list (which may include a TCI state list for a particular CC, a shared TCI state list, a TCI state pool, and so on).

Each CC in the set of multiple CCs may be configured in a respective TCI configuration mode (e.g., a joint TCI configuration mode or a separate TCI configuration mode). In some cases, a 3GPP network may only transmit the common TCI ID indication for the set of multiple CCs when it is known that each (all) of the CCs in the set of multiple CCs has a same TCI configuration mode. Similarly, and in some cases, the UE may only apply the common TCI ID indication to the set of multiple CCs when each (all) of the CCs in the set of multiple CCs has a same TCI configuration mode.

In some cases, different CCs in the set of multiple CCs may have different TCI configuration modes. For example, a first subset of CCs (a first one or more CCs) in the set of multiple CCs may be configured in a first TCI configuration mode, and a second subset of CCs (a second one or more CCs) in the set of multiple CCs may be configured in a second TCI configuration mode. In these cases, the first subset of CCs or the second subset of CCs may be identified, at 604, as the set of target CCs.

In some embodiments, the common TCI ID indication may be included in TCI update signaling received, at 602, over a CC in the set of multiple CCs. In response to determining the CC over which the TCI update signaling is received is configured in the first TCI configuration mode, the first subset of CCs may be identified as the set of target CCs. In response to determining the CC over which the TCI update signaling is received is configured in the second TCI configuration mode, the second subset of CCs may be identified as the set of target CCs.

In some embodiments, the method 600 may include receiving an indication of a TCI configuration mode to which the common TCI ID indication applies. The indication may be received in higher laying signaling, such as radio resource control (RRC) signaling, a medium access control (MAC) control element (CE) (MAC CE), or downlink control information (DCI). In response to determining the indicated TCI configuration mode is the first TCI configuration mode, the first subset of CCs may be identified as the set of target CCs. In response to determining the indicated TCI configuration mode is the second TCI configuration mode, the second subset of CCs may be identified as the set of target CCs. In some cases, the indication may indicate that, if a common TCI ID indication is received on a particular CC and BWP, the common TCI ID indication should be applied to CCs configured in a particular TCI configuration mode.

In some embodiments, the method 600 may include identifying both the first subset of CCs and the second subset of CCs (i.e., subsets of CCs configured in different TCI configuration modes) as the set of target CCs. In these embodiments, the method 600 may also include activating a first subset of respective TCI states for the first subset of CCs separately from a second subset of respective TCI states for the second subset of CCs. In some cases, a first MAC CE may activate the first subset of respective TCI states, and a second MAC CE may activate the second subset of respective TCI states. Alternatively, a single MAC CE or DCI may separately activate both the first subset of respective TCI states and the second subset of respective TCI states.

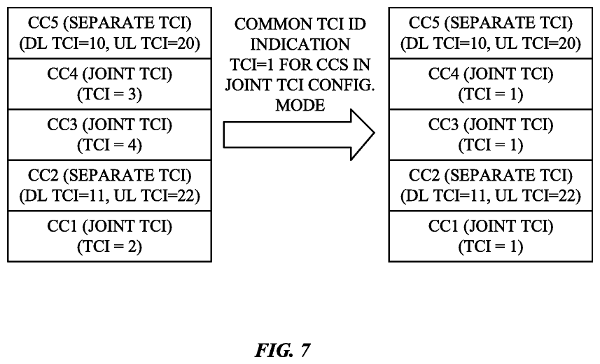

FIG. 7 shows an example application of a common TCI ID indication to a set of multiple CCs. In the example, a UE has a set of five CCs (i.e., CC1, CC2, CC3, CC4, and CC5). By way of example, a common TCI indication may be received over CC3, a CC configured in a joint TCI configuration mode. Because the common TCI indication is received over a CC configured in a joint TCI configuration mode, the common TCI indication is applied to all CCs, in the set of five CCs, that are configured in a joint TCI configuration mode. In the example, this includes CC1, CC3, and CC4. If the common TCI indication indicates TCI ID 1 (i.e., TCI=1), then each of CC1, CC3, and CC4 may be switched to TCI ID 1. The TCI states for the CCs configured in a separate TCI configuration mode (i.e., CC2 and CC5) may remain unchanged.

In some cases, the method 600 may include identifying, within the set of multiple CCs, a set of target BWPs to which the common TCI ID indication applies. For example, in some embodiments, the common TCI ID indication may be applied to all configured BWPs for the set of target CCs. The “all configured BWPs” may or may not include a BWP over which the common TCI ID indication is received.

In some embodiments, the common TCI ID indication received at 602 may be applied to only active BWPs for the set of target CCs. If the common TCI ID indication is configured to be applied to a BWP outside a first set of active BWPs that is active in a time period (e.g., a slot) in which the common TCI ID indication is received (e.g., if the TCI update signaling including the common TCI ID indication indicates a BWP that differs from a currently active BWP, indicating a BWP switch), then one of the following options may be configured by a base station. In a first option, the UE may be configured to apply the common TCI ID indication to a second set of active BWPs that is active after one or more action delays for applying the common TCI ID indication. In other words, the common TCI ID indication may be applied to BWPs that are active after a BWP switch. In a second option, the UE may be configured to apply the common TCI ID indication to the first set of active BWPs (i.e., to BWPs that are currently active). In a third option, the UE may be configured to apply the common TCI ID indication to both the first set of active BWPs and the second set of active BWPs. In some embodiments, the method 600 may include receiving, from a base station, an indication to apply the common TCI ID indication received at 602 to one or both of the first set of active BWPs or the second set of active BWPs.

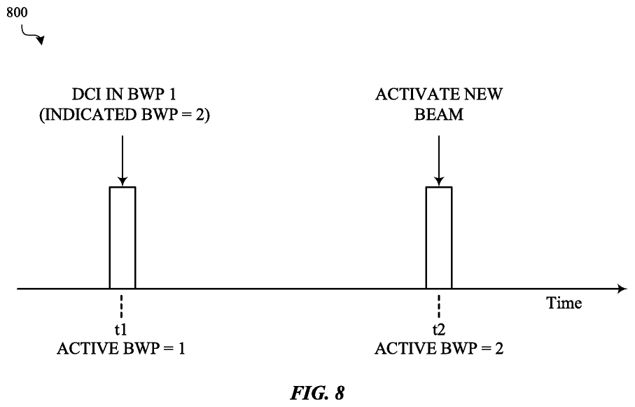

FIG. 8 shows an example application of a common TCI ID indication to a set of BWPs, of a set of multiple CCs of a UE. At a time t1 (of timeline 800), a CC of a UE may have an active BWP 1. Also at time t1, DCI may be received, over the BWP 1, indicating that the BWP should be switched to active BWP 2. If the UE is configured to apply the common TCI indication to active BWPs after BWP switching, the UE may apply the common TCI ID indication to the BWP 2 at time t2, when the common TCI ID indication is applied to the CC.

The common TCI ID indication may be received, at 602, in a MAC CE, on one CC, and applied to the set of target CCs. In some embodiments, all of the CCs in the set of multiple CCs may be configured in a same TCI configuration mode, and the set of target CCs may include all of the CCs in the set of multiple CCs (e.g., all of the CCs in a CC list). In some embodiments, the set of multiple CCs may include CCs configured in different TCI configuration modes. In these latter embodiments, the set of target CCs (i.e., a first subset of CCs within the set of multiple CCs) may be configured in a first TCI configuration mode, and a second subset of CCs within the set of multiple CCs may be configured in a second TCI configuration mode.

A first option for updating TCI for the second subset of CCs is to have a 3GPP network include a second common TCI ID indication in the MAC CE received at 602. The second common TCI ID indication may be applied to CCs having the second TCI configuration mode. In these embodiments, the method 600 may include identifying, within the set of multiple CCs, a second set of target CCs to which the second common TCI ID indication applies; and activating, for each CC in the second set of target CCs and in accord with the second common TCI ID indication, a respective TCI state in a respective TCI state list. The second set of target CCs may include the CCs that are configured in the second TCI configuration mode.

A second option for updating TCI for the second subset of CCs is to have a 3GPP network transmit a second MAC CE to the UE. The second MAC CE may include a second common TCI ID indication. In these embodiments, the method 600 may again include identifying, within the set of multiple CCs, a second set of target CCs to which the second common TCI ID indication applies; and activating, for each CC in the second set of target CCs and in accord with the second common TCI ID indication, a respective TCI state in a respective TCI state list. The second set of target CCs may include the CCs that are configured in the second TCI configuration mode.

Whether TCI activation is enabled for multiple CCs or single CCs can be configured by higher layer signaling (e.g., in RRC signaling, or in the MAC CE including the common TCI ID indication). In one example, if a CC is configured as part of a set of multiple CCs (e.g., as part of a CC list), multiple CC (or common) TCI activation may always be considered enabled. In another example, one bit of a MAC CE (e.g., the MAC CE including the common TCI ID indication) can indicate whether TCI activation for a single CC or multiple CCs is enabled.

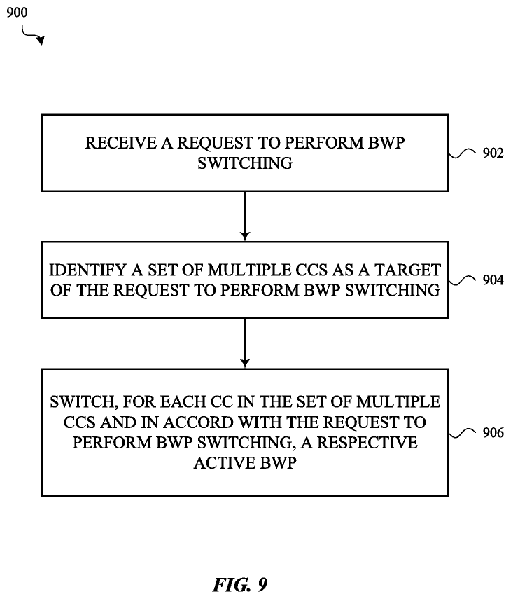

Similarly to updating TCI for multiple CCs simultaneously, latency and system overhead can be reduced by switching BWPs for multiple CCs simultaneously (as may be useful, for example, for uplink panel selection and/or inter-cell mobility). In this regard, FIG. 9 shows another example method 900 of wireless communication by a UE, which method 900 may be used to switch BWPs for multiple CCs. The method 900 may be performed by a processor of the UE, and transmissions and receptions initiated by the processor may be made using a transceiver of the UE.

At 902, the method 900 may include receiving a request to perform BWP switching. The request may be received from a base station, for example.

At 904, the method 900 may include identifying a set of multiple CCs as a target of the request to perform BWP switching. In some cases, the set of multiple CCs may be the CCs in a CC list, which CC list may be configured, for example, in RRC signaling.

At 906, the method 900 may include switching, for each CC in the set of multiple CCs and in accord with the request to perform BWP switching, a respective active BWP.

The CCs within a CC list may be within a band or a band combination. When the CCs are in a band combination, the CCs should share the same panel entity index (i.e., the CCs should share the same antenna panel). In some embodiments, the method 900 may include transmitting UE capability information to a 3GPP network (e.g., to a base station), and the UE capability information may include an indication of which band combinations should share a same panel entity index. The network may then use the UE capability information to request appropriate multiple CC BWP switching for the UE.

In some embodiments, the request to perform BWP switching may be received, at 902, in higher layer signaling (e.g., in RRC signaling or a MAC CE). In these embodiments, the request to perform BWP switching may include, for at least one serving cell to which the BWP switching applies, an indication of the serving cell (e.g., a serving cell index) and an indication of a target BWP (e.g., a target BWP index).

In some embodiments, the request to perform BWP switching may be received, at 902, in DCI. In these embodiments, the DCI may include a field for indicating (by a 3GPP network) whether the request to perform BWP switching applies to a single CC or a set of multiple CCs (e.g., the CCs in a CC list). Alternatively, the method 900 may include determining whether the request to perform BWP switching applies to a single CC or a set of multiple CCs by analyzing a CC index associated with the DCI. For example, if the CC index is within a CC list, the request to perform BWP switching may be applied to all of the CCs in the CC list; or, a default value (or values) for the CC index can indicate whether the request to perform BWP switching should be applied to a single CC (e.g., the CC over which the request to perform BWP switching is received) or applied to all CCs within a set of multiple CCs (e.g., the CCs in a CC list).

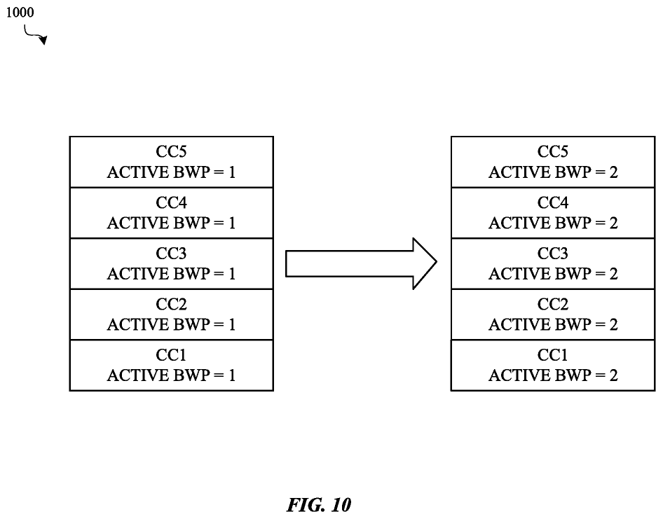

An example 1000 of BWP switching for multiple CCs is shown in FIG. 10. In the example 1000, a UE has a set of five CCs (i.e., CC1, CC2, CC3, CC4, and CC5). By way of example, each of the CCs may be configured to communicate over a BWP 1 (i.e., BWP=1) when a request to perform BWP switching to BWP 2 is received. Because the CCs are targets of the request to perform BWP switching, the UE may switch the BWP of each of the CCs to the BWP 2.

In some embodiments, the method 300 may include, after switching the respective active BWP for each CC in the set of multiple CCs, determining that no data has been received over the active BWPs for the set of multiple CCs for a period of time. In these embodiments, and in some cases, the method 300 may include switching back to one of: a set of active BWP used for the set of multiple CCs before the switch (i.e., an initial set of active BWPs), or a default set of BWPs. In other cases, the method 300 may include only switching back to a BWP in the initial or default set of BWPs for the CC(s)/BWP(s) over which no data has been received for the period of time (i.e., separately determining whether to switch the BWP for a CC back to an initial or default BWP). Whether the UE should switch back to a default or initial BWP may be configured by higher layer signaling (e.g., RRC signaling).

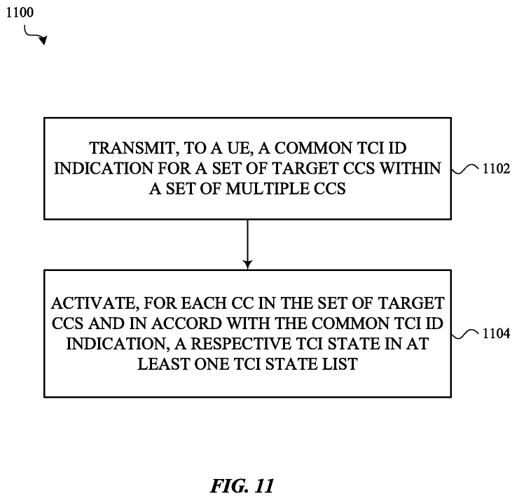

FIG. 11 shows an example method 1100 of wireless communication by a base station (e.g., a gNB), which method 1100 may be used to apply a common TCI ID indication to multiple CCs. The method 1100 may be performed by a processor of the base station, and transmissions and receptions initiated by the processor may be made using a transceiver of the base station.

At 1102, the method 1100 may include transmitting, to a UE, a common TCI ID indication for a set of target CCs within a set of multiple CCs.

At 1104, the method 1100 may include activating, for each CC in the set of target CCs and in accord with the common TCI ID indication, a respective TCI state in at least one TCI state list.

The method 1100 may be variously configured or modified as described with reference to FIG. 6.

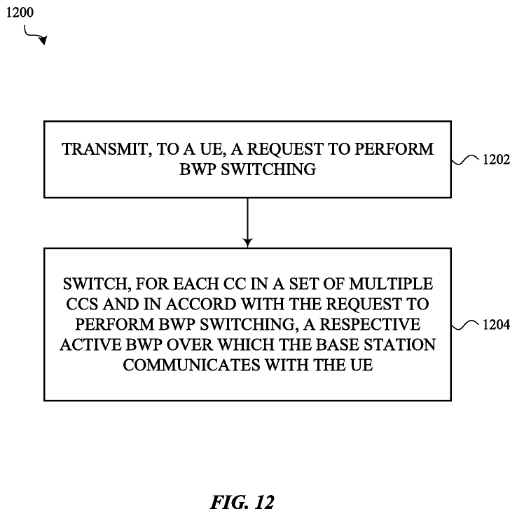

FIG. 12 shows another example method 1200 of wireless communication by a base station (e.g., a gNB), which method 1200 may be used to switch BWPs for multiple CCs. The method 1200 may be performed by a processor of the base station, and transmissions and receptions initiated by the processor may be made using a transceiver of the base station.

At 1202, the method 1200 may include transmitting, to a UE, a request to perform BWP switching.

At 1204, the method 1200 may include switching, for each CC in a set of multiple CCs and in accord with the request to perform BWP switching, a respective active BWP over which the base station communicates with the UE.

The method 1200 may be variously configured or modified as described with reference to FIG. 9.

Embodiments contemplated herein include an apparatus having means to perform one or more elements of the method 600, 900, 1100, or 1200. In the context of method 600 or 900, this apparatus may be, for example, an apparatus of a UE (such as a wireless device 1402 that is a UE, as described herein). In the context of method 1100 or 1200, this apparatus may be, for example, an apparatus of a base station (such as a network device 1420 that is a base station, as described herein).

Embodiments contemplated herein include one or more non-transitory computer-readable media storing instructions to cause an electronic device, upon execution of the instructions by one or more processors of the electronic device, to perform one or more elements of the method 600, 900, 1100, or 1200. In the context of method 600 or 900, this non-transitory computer-readable media may be, for example, a memory of a UE (such as a memory 1406 of a wireless device 1402 that is a UE, as described herein). In the context of method 1100 or 1200, this non-transitory computer-readable media may be, for example, a memory of a base station (such as a memory 1424 of a network device 1420 that is a base station, as described herein).

Embodiments contemplated herein include an apparatus having logic, modules, or circuitry to perform one or more elements of the method 600, 900, 1100, or 1200. In the context of method 600 or 900, this apparatus may be, for example, an apparatus of a UE (such as a wireless device 1402 that is a UE, as described herein). In the context of method 1100 or 1200, this apparatus may be, for example, an apparatus of a base station (such as a network device 1420 that is a base station, as described herein).

Embodiments contemplated herein include an apparatus having one or more processors and one or more computer-readable media, using or storing instructions that, when executed by the one or more processors, cause the one or more processors to perform one or more elements of the method 600, 900, 1100, or 1200. In the context of method 600 or 900, this apparatus may be, for example, an apparatus of a UE (such as a wireless device 1402 that is a UE, as described herein). In the context of the method 1100 or 1200, this apparatus may be, for example, an apparatus of a base station (such as a network device 1420 that is a base station, as described herein).

Embodiments contemplated herein include a signal as described in or related to one or more elements of the method 600, 900, 1100, or 1200.

Embodiments contemplated herein include a computer program or computer program product having instructions, wherein execution of the program by a processor causes the processor to carry out one or more elements of the method 600, 900, 1100, or 1200. In the context of method 600 or 900, the processor may be a processor of a UE (such as a processor(s) 1404 of a wireless device 1402 that is a UE, as described herein), and the instructions may be, for example, located in the processor and/or on a memory of the UE (such as a memory 1406 of a wireless device 1402 that is a UE, as described herein). In the context of method 600 or 900, the processor may be a processor of a base station (such as a processor(s) 1422 of a network device 1420 that is a base station, as described herein), and the instructions may be, for example, located in the processor and/or on a memory of the base station (such as a memory 1424 of a network device 1420 that is a base station, as described herein).

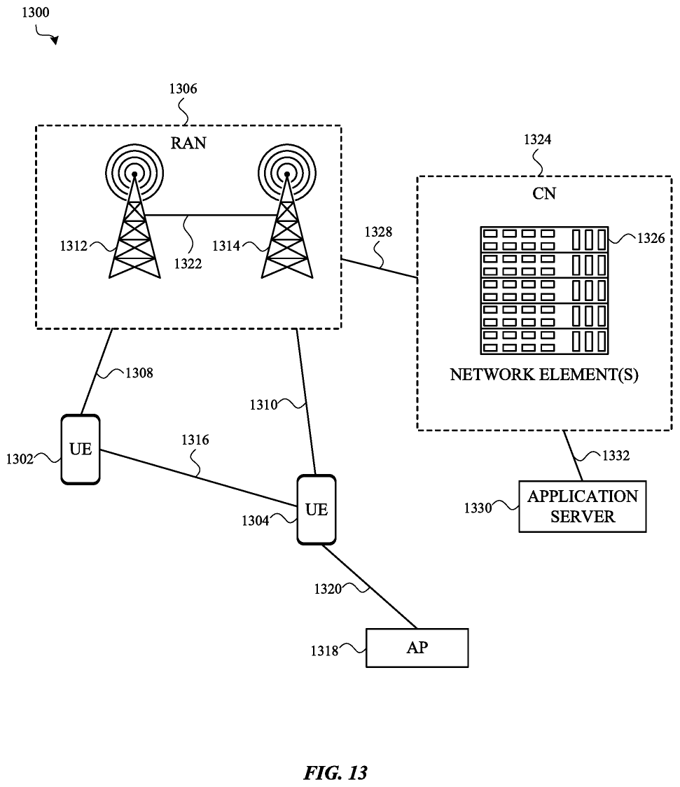

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations, such as base station 1312 and base station 1314, that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VOIP sessions, group communication sessions, etc.) for the UE 1302 and UE 1304 via the CN 1324. The application server 1330 may communicate with the CN 1324 through an IP communications interface 1332.

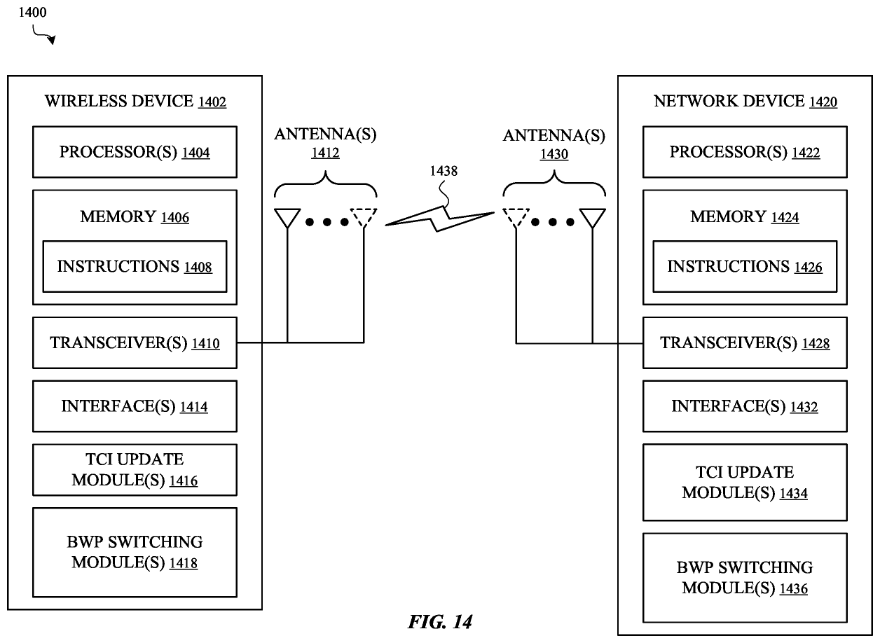

FIG. 14 illustrates a system 1400 for performing signaling 1438 between a wireless device 1402 and a network device 1420, according to embodiments disclosed herein. The system 1400 may be a portion of a wireless communications system as herein described. The wireless device 1402 may be, for example, a UE of a wireless communication system. The network device 1420 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1438) to and/or from the wireless device 1402 with other devices (e.g., the network device 1420) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a TCI update module 1416 and/or a BWP switching module 1418. The TCI update module 1416 and BWP switching module 1418 may be implemented via hardware, software, or combinations thereof. For example, the TCI update module 1416 and BWP switching module 1418 may be implemented as a processor, circuit, and/or instructions 1408 stored in the memory 1406 and executed by the processor(s) 1404. In some examples, the TCI update module 1416 and BWP switching module 1418 may be integrated within the processor(s) 1404 and/or the transceiver(s) 1410. For example, the TCI update module 1416 and BWP switching module 1418 may be implemented by a combination of software components (e.g., executed by a DSP or a general processor) and hardware components (e.g., logic gates and circuitry) within the processor(s) 1404 or the transceiver(s) 1410.

The TCI update module 1416 may be used for various aspects of the present disclosure, for example, aspects of FIGS. 1-8. The TCI update module 1416 may be configured to, for example, receive a common TCI ID indication from another device (e.g., the network device 1420).

The BWP switching module 1418 may be used for various aspects of the present disclosure, for example, aspects of FIGS. 1-5 and 9. The BWP switching module 1418 may be configured to, for example, perform BWP switching.

The network device 1420 may include one or more processor(s) 1422. The processor(s) 1422 may execute instructions such that various operations of the network device 1420 are performed, as described herein. The processor(s) 1422 may include one or more baseband processors implemented using, for example, a CPU, a DSP, an ASIC, a controller, an FPGA device, another hardware device, a firmware device, or any combination thereof configured to perform the operations described herein.

The network device 1420 may include a memory 1424. The memory 1424 may be a non-transitory computer-readable storage medium that stores instructions 1426 (which may include, for example, the instructions being executed by the processor(s) 1422). The instructions 1426 may also be referred to as program code or a computer program. The memory 1424 may also store data used by, and results computed by, the processor(s) 1422.

The network device 1420 may include one or more transceiver(s) 1428 that may include RF transmitter and/or receiver circuitry that use the antenna(s) 1430 of the network device 1420 to facilitate signaling (e.g., the signaling 1438) to and/or from the network device 1420 with other devices (e.g., the wireless device 1402) according to corresponding RATs.

The network device 1420 may include one or more antenna(s) 1430 (e.g., one, two, four, or more). In embodiments having multiple antenna(s) 1430, the network device 1420 may perform MIMO, digital beamforming, analog beamforming, beam steering, etc., as has been described.

The network device 1420 may include one or more interface(s) 1432. The interface(s) 1432 may be used to provide input to or output from the network device 1420. For example, a network device 1420 that is a base station may include interface(s) 1432 made up of transmitters, receivers, and other circuitry (e.g., other than the transceiver(s) 1428/antenna(s) 1430 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1420 may include a TCI update module 1434 and/or a BWP switching module 1436. The TCI update module 1434 and BWP switching module 1436 may be implemented via hardware, software, or combinations thereof. For example, the TCI update module 1434 and BWP switching module 1436 may be implemented as a processor, circuit, and/or instructions 1426 stored in the memory 1424 and executed by the processor(s) 1422. In some examples, the TCI update module 1434 and BWP switching module 1436 may be integrated within the processor(s) 1422 and/or the transceiver(s) 1428. For example, the TCI update module 1434 and BWP switching module 1436 may be implemented by a combination of software components (e.g., executed by a DSP or a general processor) and hardware components (e.g., logic gates and circuitry) within the processor(s) 1422 or the transceiver(s) 1428.

The TCI update module 1434 may be used for various aspects of the present disclosure, for example, aspects of FIGS. 1-8 and 11. The TCI update module 1434 may be configured to, for example, transmit a common TCI ID indication to another device (e.g., the wireless device 1402).

The BWP switching module 1436 may be used for various aspects of the present disclosure, for example, aspects of FIGS. 1-5 and 12. The BWP switching module 1436 may be configured to, for example, request another device (e.g., the wireless device 1402) to perform BWP switching.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
receive, via the transceiver, a common transmission configuration indicator (TCI) identifier (ID) indication for a set of target component carriers (CCs) within a set of multiple CCs;
identify, within the set of multiple CCs, the set of target CCs to which the common TCI ID indication applies; and
activate, for each CC in the set of target CCs and in accord with the common TCI ID indication, a respective TCI state in at least one TCI state list.

2. The UE of claim 1, wherein:
each CC in the set of multiple CCs has a same TCI configuration mode, selected from a joint TCI configuration mode or a separate TCI configuration mode; and
the set of target CCs includes each CC in the set of multiple CCs.

3. The UE of claim 1, wherein:
a first subset of CCs in the set of multiple CCs is configured in a first TCI configuration mode;
a second subset of CCs in the set of multiple CCs is configured in a second TCI configuration mode; and
the processor identifies one of the first subset of CCs or the second subset of CCs as the set of target CCs.

4. The UE of claim 3, wherein:
the common TCI ID indication is included in TCI update signaling received over a CC in the set of multiple CCs;
the CC is configured in the first TCI configuration mode; and
in response to determining the CC is configured in the first TCI configuration mode, the processor identifies the first subset of CCs as the set of target CCs.

5. The UE of claim 3, wherein:
the processor is configured to,
receive, via the transceiver, an indication of a TCI configuration mode to which the common TCI ID indication applies;
determine the indicated TCI configuration mode is the first TCI configuration mode; and
in response to determining the indicated TCI configuration mode is the first TCI configuration mode, the processor identifies the first subset of CCs as the set of target CCs.

6. The UE of claim 1, wherein:
a first subset of CCs in the set of multiple CCs is configured in a first TCI configuration mode;
a second subset of CCs in the set of multiple CCs is configured in a second TCI configuration mode;
the processor identifies both the first subset of CCs and the second subset of CCs as the set of target CCs; and
the processor activates a first subset of respective TCI states for the first subset of CCs separately from a second subset of respective TCI states for the second subset of CCs.

7. The UE of claim 1, wherein the processor is configured to apply the common TCI ID indication to all configured bandwidth parts (BWPs) for the set of target CCs.

8. The UE of claim 1, wherein the processor is configured to apply the common TCI ID indication to only active bandwidth parts (BWPs) for the set of target CCs.

9. The UE of claim 8, wherein:
the common TCI indication is configured to be applied to a BWP outside a first set of active BWPs that is active in a time period in which the common TCI ID indication is received; and
the processor is configured to apply the common TCI ID indication to a second set of active BWPs that is active after one or more action delays for applying the common TCI ID indication.

10. The UE of claim 8, wherein:
the common TCI indication is configured to be applied to a BWP outside a set of active BWPs that is active in a time period in which the common TCI ID indication is received; and
the processor is configured to apply the common TCI ID indication to the set of active BWPs that is active in the time period in which the common TCI ID indication is received.

11. The UE of claim 8, wherein:
the common TCI indication is configured to be applied to a BWP outside a first set of active BWPs that is active in a time period in which the common TCI ID indication is received; and
the processor is configured to apply the common TCI ID indication to both the first set of active BWPs and a second set of active BWPs, the second set of active BWPs active after one or more action delays for applying the common TCI ID indication.

12. The UE of claim 8, wherein:
the processor is configured to receive, via the transceiver, an indication to apply the common TCI ID indication to one or both of,
a first set of active BWPs that is active in a time period in which the common TCI indication is received; or
a second set of active BWPs that is active after one or more action delays for applying the common TCI ID indication.

13. The UE of claim 1, wherein the common TCI ID indication is received in a medium access control (MAC) control element (CE) (MAC CE) on one CC and applied to the set of target CCs.

14. The UE of claim 13, wherein:
the set of target CCs is configured in a first TCI configuration mode;
the MAC CE includes a second common TCI ID indication; and
the processor is configured to,
identify, within the set of multiple CCs, a second set of target CCs to which the second common TCI ID indication applies; and
activate, for each CC in the second set of target CCs and in accord with the second common TCI ID indication, a respective TCI state in at least one TCI state list.

15. The UE of claim 13, wherein:
the set of target CCs is configured in a first TCI configuration mode; and
the processor is configured to,
receive a second MAC CE including a second common TCI ID indication;
identify, within the set of multiple CCs, a second set of target CCs to which the second common TCI ID indication applies; and
activate, for each CC in the second set of target CCs and in accord with the second common TCI ID indication, a respective TCI state in at least one TCI state list.

16. A user equipment (UE), comprising:
a transceiver; and
a processor configured to,
receive, via the transceiver, a request to perform bandwidth part (BWP) switching;
identify a set of multiple component carriers (CCs) as a target of the request to perform BWP switching; and
switch, for each CC in the set of multiple CCs and in accord with the request to perform BWP switching, a respective active BWP.

17. The UE of claim 16, wherein:
the set of multiple CCs share a same band combination; and
the processor is configured to transmit, via the transceiver and in UE capability information, an indication of which band combinations should share a same panel entity index.

18. The UE of claim 16, wherein:
the request to perform BWP switching is received in radio resource control (RRC) signaling or a medium access control (MAC) control element (CE) (MAC CE); and
the request to perform BWP switching includes, for at least one serving cell to which the BWP switching applies, an indication of the serving cell and an indication of a target BWP.

19. The UE of claim 16, wherein:
the request to perform BWP switching is received in downlink control information (DCI); and
whether the request to perform BWP switching applies to a single CC or the set of multiple CCs is indicated in,
a field for indicating whether the request to perform BWP switching applies to the single CC or the set of multiple CCs; or
a CC index.

20. The UE of claim 16, wherein:
the processor is configured to,
determine, after switching the respective active BWP for each CC in the set of multiple CCs, that no data has been received over active BWPs for the set of multiple CCs for a period of time; and
switch back to one of,
a set of active BWPs used for the set of multiple CCs before the switch; or
a default set of BWPs.
